(19) United States
(12) Patent Application Publication
(10) Pub. No.: US 2024/0157745 A1
(43) Pub. Date: May 16, 2024

(54) Support System With Air Reservoir

(71) Applicant: APPLE INC., Cupertino, CA (US)

(72) Inventors: Samuel G. Fowle, San Francisco, CA (US); Troy A. Carter, Sunnyvale, CA (US)

(21) Appl. No.: 18/418,459

(22) Filed: Jan. 22, 2024

Related U.S. Application Data
(63) Continuation of application No. PCT/US2022/043097, filed on Sep. 9, 2022.
(60) Provisional application No. 63/300,708, filed on Jan. 19, 2022.
(60) Provisional application No. 63/246,563, filed on Sep. 21, 2021.

(51) Int. Cl. B60G 11/27; B60G 11/28; B60G 17/048; B60G 17/052

(52) U.S. Cl. CPC B60G 11/27; B60G 11/28; B60G 17/048; B60G 17/052; B60G 2202/152; B60G 2202/412; B60G 2500/2014; B60G 2500/202

(57) ABSTRACT

A support system includes an air spring includes an air spring housing, defines an internal working volume, and is configured to support a body structure. The support system also includes an air reservoir that is supported by the air spring housing and defines a reservoir volume that is in fluid communication with the internal working volume of the air spring.

### CROSS-REFERENCE TO RELATED APPLICATIONS

This application is a continuation of International Application No. PCT/US2022/043097, filed on Sep. 9, 2022, which claims the benefit of U.S. Provisional Application No. 63/300,708, filed on Jan. 19, 2022, and also claims the benefit of U.S. Provisional Application No. 63/246,563, filed on Sep. 21, 2021. The contents of the foregoing applications are hereby incorporated by reference in their entireties herein for all purposes.

### FIELD

The present disclosure relates generally to the field of support systems.

### BACKGROUND

Some systems support a sprung mass relative to an unsprung mass. The sprung mass may include a body. The unsprung mass may include components that are configured to contact a surface. Some support systems function to set a height and to absorb vibrations.

### SUMMARY

A first aspect of the disclosure is a suspension system that includes an air spring that includes an air spring housing, defines an internal working volume, and is configured to support a vehicle body structure with respect to a wheel assembly. The suspension system also includes an air reservoir that is supported by the air spring housing and defines a reservoir volume that is in fluid communication with the internal working volume of the air spring.

In some implementations of the suspension system according to the first aspect of the disclosure, the air reservoir is supported by the air spring so that it moves in unison with at least part of the air spring housing. In some implementations of the suspension system according to the first aspect of the disclosure, the suspension system also includes a first mounting structure that is configured for connection to the wheel assembly, and a second mounting structure that is configured for connection to the vehicle body structure, wherein the air reservoir is supported between the first mounting structure and the second mounting structure.

In some implementations of the suspension system according to the first aspect of the disclosure, an air passage extends through the air spring housing to allow fluid communication between the internal working volume of the air spring and the reservoir volume of the air reservoir. In some implementations of the suspension system according to the first aspect of the disclosure, the air reservoir includes a reservoir housing part that is connected to the air spring housing, and the reservoir volume is defined by the reservoir housing part and the air spring housing. In some implementations of the suspension system according to the first aspect of the disclosure, the air reservoir forms part of a load path between the air spring and the wheel assembly.

In some implementations of the suspension system according to the first aspect of the disclosure, the suspension system also includes a support structure that is connected to the air spring housing and forms part of a load path between the air spring and the wheel assembly. The air reservoir may be mounted on the support structure. The air reservoir may be defined by a hollow interior of the support structure. The air reservoir may include a reservoir housing part that is connected to the air spring housing and is connected to the support structure, and the reservoir volume is defined by the reservoir housing part, the air spring housing, and the support structure.

In some implementations of the suspension system according to the first aspect of the disclosure, the suspension system also includes a control arm having a first end and a second end, wherein the first end of the control arm is configured for connected to the vehicle body structure, the second end is configured for connection to the wheel assembly, and the support structure is connected to the control arm between the first end of the control arm and the second end of the control arm. In some implementations of the suspension system according to the first aspect of the disclosure, the support structure is connected to a wheel hub assembly of the wheel assembly.

A second aspect of the disclosure is a suspension system that includes an air spring that is configured to support a vehicle body structure with respect to a wheel assembly, wherein the air spring includes a lower housing part, an upper housing part, and an air spring membrane that cooperate to define an internal working volume of the air spring, wherein the internal working volume of the air spring varies volumetrically in correspondence to movement of the lower housing part with respect to the upper housing part. The suspension system also includes an air reservoir that is supported with respect to the lower housing part of the air spring for movement in unison with the lower housing part of the air spring and defines a reservoir volume. The suspension system also includes an air passage that extends through the lower housing part and is in fluid communication with the internal working volume of the air spring and the reservoir volume of the air reservoir to allow exchange of air between the internal working volume of the air spring and the reservoir volume in response to contraction and expansion of the air spring.

In some implementations of the suspension system according to the second aspect of the disclosure, fluid communication between the internal working volume of the air spring and the reservoir volume of the air reservoir through the air passage defines a total working volume for the air spring that includes the internal working volume of the air spring and the reservoir volume of the air reservoir. In some implementations of the suspension system according to the first aspect of the disclosure, the air passage is free from valves between internal working volume of the air spring and the reservoir volume of the air reservoir.

In some implementations of the suspension system according the second aspect of the disclosure, an active suspension actuator is connected to the upper housing part and the lower housing part and is configured to move the upper housing part and the lower housing part relative to each other. The active suspension actuator may define an actuator volume that is located in the upper housing part and is in fluid communication with the internal working volume of the air spring. The active suspension actuator may include a shaft that is configured to transfer load between the upper housing part and the lower housing part, a passage is formed through the shaft, and the actuator volume is in fluid communication with the internal working volume of the air spring through the passage of the shaft.

A third aspect of the disclosure is a suspension system that includes an air spring that defines and internal working volume, and an air reservoir that defines a reservoir volume and is in fluid communication with the internal working volume of the air spring so that the internal working volume of the air spring and the reservoir volume of the air reservoir cooperate to define a total a working volume for the air spring. The suspension system also includes an upper mounting structure that is configured for connection to a vehicle body structure, a lower mounting structure that is configured for connection to a wheel assembly, and a support structure that defines a load path between the air spring and the lower mounting structure, wherein the air reservoir is fixed to the support structure.

In some implementations of the suspension system according to the third aspect of the disclosure, the air reservoir has a forked configuration. The air reservoir may include a first air tank that is located adjacent to a first fork portion of the support structure and a second air tank that is located adjacent to a second fork portion of the support structure. The air reservoir may include a reservoir housing that includes a first housing fork portion that is located adjacent to a first fork portion of the support structure, and a second housing fork portion that is located adjacent to a second fork portion of the support structure.

### BRIEF DESCRIPTION OF THE DRAWINGS

FIG. 1 is an illustration that shows a vehicle suspension system.

FIG. 2 is an illustration that shows a vehicle suspension system according to an alternative implementation.

FIG. 3 is a front cross-section illustration that shows a suspension actuator assembly according to a first example.

FIG. 4 is a side cross-section illustration of the suspension actuator of FIG. 3.

FIG. 5 is a front cross-section illustration that shows a suspension actuator assembly according to a second example.

FIG. 6 is a side illustration of the suspension actuator of FIG. 5.

FIG. 7 is a front cross-section illustration that shows a suspension actuator assembly according to a third example.

FIG. 8 is a side illustration of the suspension actuator of FIG. 7.

FIG. 9 is a front cross-section illustration that shows a suspension actuator assembly according to a fourth example.

FIG. 10 is a side illustration of the suspension actuator of FIG. 9.

FIG. 11 is a front cross-section illustration that shows an alternative implementation of the suspension actuator assembly of FIG. 3.

FIG. 12 is a front cross-section illustration that shows an alternative implementation of the suspension actuator assembly of FIG. 5.

FIG. 13 is a front cross-section illustration that shows an alternative implementation of the suspension actuator assembly of FIG. 7.

FIG. 14 is a front cross-section illustration that shows an alternative implementation of the suspension actuator assembly of FIG. 9.

FIG. 15 is a block diagram that shows an example of a vehicle.

### DETAILED DESCRIPTION

The description herein relates to suspension systems that include an air spring that has an internal working volume and an air reservoir that has a reservoir volume. The internal working volume of the air spring varies volumetrically (e.g., the volume changes) during use of the air spring, for example, as applied loads cause contraction and expansion of the air spring. The reservoir volume may be fixed. Fluid communication between the internal working volume of the air spring and the reservoir volume allows for air exchange, which allows the air reservoir to serve as an additional working volume for the air spring, as the air in the internal working volume of the air spring and the air in the reservoir volume may compress and decompress together in response to contraction and expansion of the air spring. Because the air reservoir is adjacent to the air spring, this increase in working volume is achieved without increasing the size of the air spring itself, and without incurring the air pressure losses associated with use of a remotely positioned air tank.

To package the air reservoir efficiently, and at a position that is near the air spring, the air reservoir is included in a suspension actuator assembly that is configured to support a body structure of a vehicle with respect to a wheel assembly of the vehicle. As an example, the air reservoir may be connected to the air spring so that it moves in unison with at least part of a housing of the air spring. As an example, the air reservoir may be connected to the suspension actuator assembly between a first mounting structure that is configured to connect the suspension actuator to the wheel assembly (e.g., either directly or indirectly), and a second mounting structure that is configured to connect the suspension actuator to the body structure of the vehicle.

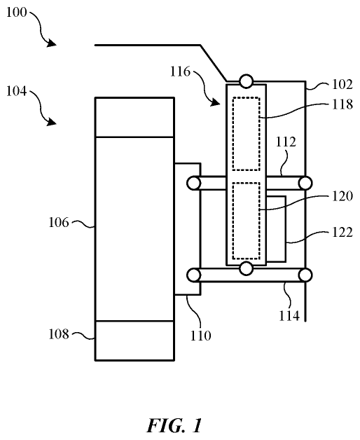

FIG. 1 is an illustration that shows a suspension system 100 (e.g., a vehicle suspension system) that supports a vehicle structure 102 (e.g., a vehicle body structure) with respect to a wheel assembly 104. The suspension system 100 is configured to reduce transmission of vibrations to a sprung mass from an unsprung mass using passive suspension components and active suspension components. In this example, the sprung mass is the vehicle structure 102 and the unsprung mass is the wheel assembly 104. A vehicle may include multiple wheel assemblies configured equivalently to the wheel assembly 104 and which are connected to the vehicle structure 102 by the suspension system 100 by duplication of components of the suspension system. As an example, a vehicle may include four wheel assemblies that are connected to the vehicle structure 102 by the suspension system 100 to support the vehicle structure 102 relative to a roadway surface or other surface.

The vehicle structure 102 includes components that are part of the sprung mass of the vehicle. The vehicle structure 102 may be a multi-part structure. As examples, the vehicle structure 102 may be or include a frame, a subframe, a unibody, a body, a monocoque, and/or other types of vehicle frame and body structures. The vehicle structure 102 may include internal structure components (e.g., frame rails, structural pillars, etc.), and external aesthetic components (e.g., body panels).

The wheel assembly 104 includes a wheel 106, a tire 108, and a wheel hub assembly 110. The wheel 106, the tire 108, and the wheel hub assembly 110 are all conventional components. For example, the wheel 106 may be a steel wheel of conventional design that supports the tire 108, which may be a pneumatic tire. The wheel hub assembly 110 includes non-rotating components that support the wheel 106, such as a steering knuckle or a suspension knuckle. The wheel hub assembly 110 mounts the wheel 106 and the tire 108 for rotation using a conventional structure such as wheel bearing. Propulsion, steering, and/or braking components may also be connected to and or integrated into the wheel 106 and/or the wheel hub assembly 110.

To support the vehicle structure 102 with respect to wheel assembly 104, the suspension system 100 may include an upper control arm 112, a lower control arm 114, and a suspension actuator assembly 116. The upper control arm 112 and the lower control arm 114 are connected to the wheel hub assembly 110 and the vehicle structure 102 by pivot joints, or other joints that allow rotation in one or more degrees of rotational freedom. Thus, the wheel hub assembly 110 is movable with respect to the vehicle structure 102, for example, in a generally vertical direction.

As will be described herein, in the illustrated implementation, the suspension actuator assembly 116 includes an active suspension actuator 118, an air spring 120, and an air reservoir 122. By inclusion of the active suspension actuator 118 and the air spring 120, the suspension actuator assembly 116 may passively absorb a portion of the vibrations (e.g., low frequency vibrations) experienced by the wheel assembly 104 using the air spring 120, and may counteract a portion of the vibrations (e.g., high frequency vibrations) experienced by the wheel assembly 104 using the active suspension actuator 118. In this manner, the suspension actuator assembly 116 reduces transmission of vibrations from the wheel assembly 104 to the vehicle structure 102.

The active suspension actuator 118 can be controlled to in response to motion of the vehicle structure 102 relative to the wheel assembly 104, for example, by extending and retracting to apply forces between the vehicle structure 102 and the wheel assembly 104 in positive and negative directions to counteract high frequency vibrations. The active suspension actuator 118 may be a linear actuator or another type of actuator. As one example, the active suspension actuator 118 may be a hydraulic piston-cylinder actuator. As another example, the active suspension actuator 118 may be a pneumatic piston-cylinder actuator. As another example, the active suspension actuator 118 may be an electromagnetic linear actuator. As another example, the active suspension actuator 118 may be a screw actuator (e.g., including a lead screw or a ball screw) that is driven by a rotary electric motor. Other types of actuators may be used as the active suspension actuator 118 to implement active suspension control. The air spring 120 is a generally passive component that can be adjusted (e.g., by adding or removing air) to adjust the nominal ride height of the vehicle. The air reservoir 122 is located adjacent to the air spring 120 and provides additional working volume of air to the air spring 120 which may, for example, allow the air spring 120 to operate at a desired spring rate without enlarging the housing of the air spring 120 itself, which can allow for improved use of packaging space.

In the illustrated implementation, the active suspension actuator 118 the air spring 120 are included as components of the suspension actuator assembly 116. In an alternative implementation, the active suspension actuator 118 and the air spring 120 may be separate and may be connected between the vehicle structure 102 and the wheel assembly 104 by separate mounting connections.

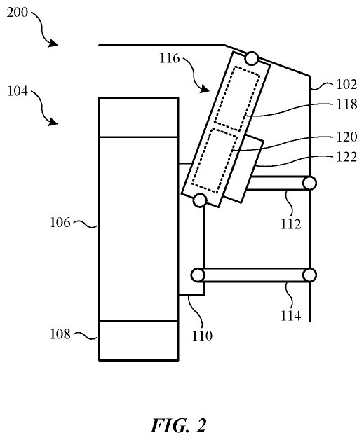

In the implementation shown in FIG. 1, an upper end of the suspension actuator assembly 116 is connected to the vehicle structure 102, and a lower end of the suspension actuator assembly 116 is connected to the lower control arm 114. In an alternative implementation of a suspension system 200, as shown in FIG. 2, an upper end of the suspension actuator assembly 116 is connected to the vehicle structure 102, and a lower end of the suspension actuator assembly is connected to the wheel hub assembly 110, and the suspension system 200 is otherwise the same as the suspension system 100. Other configurations may be used in addition to these examples.

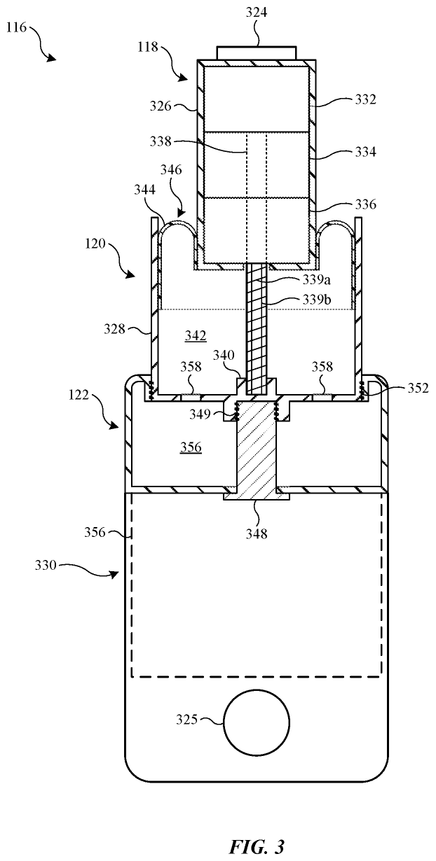

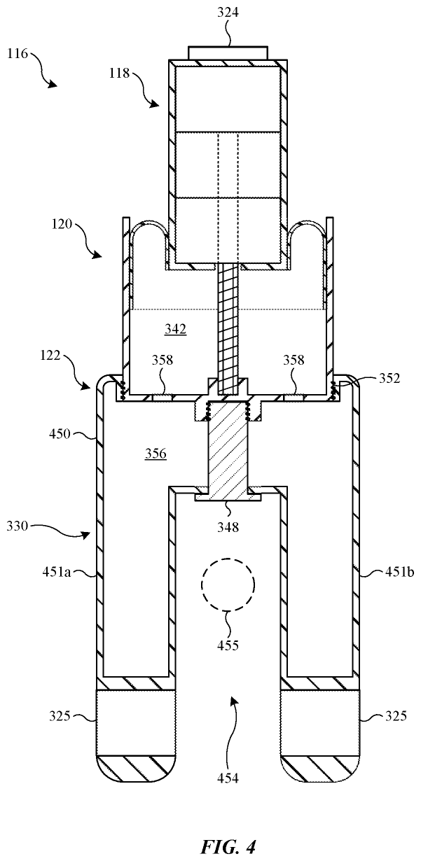

FIG. 3 is a front cross-section illustration that shows the suspension actuator assembly 116 according to a first example. FIG. 4 is a side cross-section illustration that shows the suspension actuator assembly 116. The suspension actuator assembly is configured to change length according to operation of the active suspension actuator 118 and the air spring 120. In particular, the suspension actuator assembly 116 is configured to extend (e.g., lengthen) and retract (e.g., shorten) in order to absorb vibrations and/or apply forces between the wheel assembly 104 and the vehicle structure 102. Thus, the length of the suspension actuator assembly 116 may vary between a minimum length and a maximum length.

The suspension actuator assembly 116 includes a top mount 324 that is configured to connect the upper end of the suspension actuator assembly 116 to the vehicle structure 102, either directly or indirectly. The suspension actuator assembly 116 also includes a bottom mount 325 that is configured to connect the lower end of the suspension actuator assembly 116 wheel assembly 104, either directly or indirectly, such as by connection to the lower control arm 114 or the wheel hub assembly 110. The top mount 324 and the bottom mount 325 are configured to connect to structures associated with the vehicle structure 102 and the wheel assembly 104, respectively, using conventional structures such as a pin, a ball joint, fasteners, a clamping structure, or another suitable type of fastening structure, to allow the suspension actuator assembly 116 to transfer forces between the sprung mass of the vehicle and the unsprung mass of the vehicle. Because the air reservoir 122 is part of the suspension actuator assembly 116, it is located between and supported between the bottom mount 325, which is a mounting structure that is configured for connection to the wheel assembly 104, and the top mount 324, which is a mounting structure that is configured for connection to the vehicle structure 102. The top mount 324 and the bottom mount 325 may be referred to, for example, as a first mounting structure and a second mounting structure, or as an upper mounting structure and a lower mounting structure.

The suspension actuator assembly 116 defines a first load path between the top mount 324 and the bottom mount 325 (and thus between the vehicle structure 102 and the wheel assembly 104) through the active suspension actuator 118, and defines a second load path between the top mount 324 and the bottom mount 325 through the air spring 120. Portions of the first load path and the second load path may travel through the same structures, and these may be referred to as a load path or a combined load path.

The first and second load paths cooperatively function to transfer force axially between the wheel assembly 104 and the vehicle structure 102. The first load path is configured to carry a portion of the dynamic load between the vehicle structure 102 and the wheel assembly 104 and provides primary damping functions of the suspension system 100. The second load path is configured to carry a gravity preload of the vehicle (i.e., load due to gravity irrespective of any dynamic loading) along with a portion of a dynamic load between the vehicle structure 102 and the wheel assembly 104. Stated differently, the first load path is intended to absorb high-frequency vibrations, while the first load path is intended to set a ride height for the vehicle and is intended to absorb low-frequency vibrations.

The suspension actuator assembly 116 includes an upper housing part 326, a lower housing part 328, and a support structure 330 (e.g., a support). The upper housing part 326 and the lower housing part 328 are generally cylindrical structures that extend along a longitudinal axis of the suspension actuator assembly 116. The upper housing part 326 extends from the upper end of the suspension actuator assembly 116 and the top mount 324 downward along a longitudinal axis of the suspension actuator assembly 116 toward the lower housing part 328. The lower housing part 328 is located between the upper housing part 326 and the support structure 330, and is movable relative to the upper housing part 326 by operation of the active suspension actuator 118 and the air spring 120. The support structure 330 extends upward from the lower end of the suspension actuator assembly 116 and the bottom mount 325 toward the air spring 120 and is rigidly connected to part of the air spring 120.

The upper housing part 326 and the lower housing part 328 may be telescopically related for relative longitudinal movement according to extension and retraction of the suspension actuator assembly 116. This configuration defines an overlapping region where the upper housing part 326 is spaced radially inward from the lower housing part 328.

The active suspension actuator 118 is a linear actuator that is connected to the upper housing part 326 and the lower housing part 328 to define the first load path, and is configured to move the upper housing part 326 and the lower housing part 328 longitudinally relative to each other. In the illustrated implementation, the active suspension actuator 118 is screw actuator, specifically, a ball screw actuator, but other types of linear actuators may be used. As an example, the active suspension actuator may include a motor 332 (e.g., a rotary electric motor), a ball nut 334, a ball spline 336, a shaft 338 having a helical groove 339a and longitudinal grooves 339b, and a shaft coupler 340. The motor 332, the ball nut 334, and the ball spline 336 are located in the upper housing part 326. The shaft 338 is located in the upper housing part 326 where it is engaged with the ball nut 334 and the ball spline 336, and the shaft 338 extends from the upper housing part 326 into the lower housing part 328 where it is connected to the lower housing part 328 by the shaft coupler 340 so that the shaft 338 is fixed to the lower housing part 328. Thus, the first load path transfers load between the upper housing part 326 and the lower housing part 328 through the shaft 338.

The ball nut 334 and the ball spline 336 cooperate to cause extension and retraction of the shaft 338 relative to the upper housing part 326. The ball nut 334 is a conventional component that is analogous in function to a threaded nut, but uses recirculating ball bearings that recirculate along a helical path instead of using a screw thread, in order to reduce friction. All or part of the ball nut 334 is configured to rotate relative to the upper housing part 326. The ball spline 336 is a conventional component that is analogous in function to a collar having longitudinal splines, but uses recirculating ball bearings that recirculate along longitudinal paths instead of using splines, in order to reduce friction. The ball spline 336 is fixed against rotation relative to the upper housing part 326.

The motor 332 is configured to rotate the ball nut 334, which is engaged with the helical groove 339a of the shaft 338. The shaft 338, however, is restrained from rotating by engagement of the ball spline 336 with the longitudinal grooves 339b of the shaft 338. As a result, when the motor 332 rotates, the resulting rotation of the ball nut 334 causes extension or retraction (dependent on direction of rotation) of the shaft 338 along its longitudinal axis, since the shaft 338 is restrained from rotating. This extension or retraction causes a corresponding longitudinal movement of the lower housing part 328 with respect to the upper housing part 326 and a corresponding lengthening or shortening of the suspension actuator assembly 116.

The second load path is defined by the air spring 120. The upper housing part 326 and the lower housing part 328 cooperate to define a housing of the air spring 120, which defines an internal working volume 342 inside the space defined between the upper housing part 326 and the lower housing part 328. Accordingly, the upper housing part 326 may be referred to as an upper air spring housing part, the lower housing part 328 may be referred to as a lower air spring housing part, and the upper housing part 326 and the lower housing part 328 may be referred to collectively as an air spring housing. The volume (e.g., the amount of space enclosed) of the internal working volume 342 of the air spring 120 varies in accordance with relative movement of the upper housing part 326 and the lower housing part 328. Thus, the internal working volume 342 varies volumetrically in correspondence to movement of the upper housing part 326 with respect to the lower housing part 328.

A working gas (e.g., air) is contained within the internal working volume 342 of the air spring 120 and increases and decreases in pressure in correspondence to relative movement of the upper housing part 326 and the lower housing part 328 because this movement causes a change in volume of the internal working volume 342. The pressure of the internal working volume 342 of the air spring 120 supports the upper housing part 326 relative to the lower housing part 328.

With the exception of fluid communication between the internal working volume 342 and the air reservoir 122, the internal working volume 342 is sealed to contain the gas within the internal working volume 342, for example, by inclusion of sealing structures that are, for example, connected to the upper housing part 326 and the lower housing part 328. The internal working volume 342 may include connections, for example, by valves, gas lines, and/or other structures, that allow supply of part of the working gas to the internal working volume 342 and allow discharge of part of the working gas from the internal working volume 342. This allows, for example, changes in the ride height of the vehicle.

To contain the working gas within the internal working volume 342 while allowing relative motion of the upper housing part 326 and the lower housing part 328, the air spring 120 includes an air spring membrane 344 that extends across a radial gap 346 between the upper housing part 326 and the lower housing part 328 in the overlapping region where the upper housing part 326 is spaced radially inward from the lower housing part 328. The air spring membrane 344 is a thin sheet of flexible material having an annular, tube-like configuration (e.g., a flexible sleeve). Thus, the air spring membrane 344 is a flexible structure that cooperates with the upper housing part 326 and the lower housing part 328 to define the internal working volume 342 of the air spring 120. The air spring membrane 344 is connected to the upper housing part 326 and the lower housing part 328 at the radial gap 346 to prevent the working gas from escaping the internal working volume 342 at the radial gap 346 while allowing relative motion of upper housing part 326 and the lower housing part 328. The air spring membrane 344 may also be referred to as an air spring sleeve, an air sleeve, a diaphragm, or an air spring diaphragm. In the illustrated example, the air spring membrane 344 is configured in a rolling lobe configuration in which a u-shaped turn is formed between first and second ends of the air spring membrane 344, which are secured to the upper housing part 326 and the lower housing part 328, respectively.

The support structure 330 is a static structure that is rigidly connected to the lower housing part 328 of the air spring 120, and extends downward therefrom. In the illustrated implementations, the support structure 330 is connected to the lower housing part 328 of the air spring by a connecting rod 348. The connecting rod 348 extends generally along the longitudinal axis of the suspension actuator assembly 116, upward through the support structure 330 to a threaded connection 349 of the connecting rod 348 to the lower housing part 328 in order to secure the support structure 330 to the lower housing part 328. Other types of connecting structures or methods may be used to connect the support structure 330 to the lower housing part 328 of the air spring 120.

The support structure 330 is a structural member that defines a load path between the bottom mount 325 and the lower housing part 328 of the air spring 120, and thereby defines part of the combined load path by which loads transmitted by the first load path through the active suspension actuator 118 and loads transmitted by the second load path through the air spring 120 are transmitted through the suspension actuator assembly 116 between the top mount 324 and the bottom mount 325, which may be referred to as mounts or mounting structures (e.g., first and second mounts or first and second mounting structures). The bottom mount 325 is formed on, defined by, or connected to the support structure 330 at the lower end thereof. In the illustrated implementation, the bottom mount 325 is depicted as a bore that extends through the support structure 330, for example, for receiving a pin to connect the support structure 330 to the lower control arm 114 or another portion of the suspension system 100 that is part of the unsprung mass and is connected to the wheel assembly 104. Thus, for example, the suspension system 100 may include the lower control arm 114, which has a first end and a second end, wherein the first end of the lower control arm 114 is configured for connected to the vehicle structure 102, the second end is configured for connection to the wheel assembly 104, and the support structure 330 is connected to the lower control arm 114 between the first end of the lower control arm 114 and the second end of the lower control arm 114.

In the illustrated implementation, and as best seen in FIG. 4, the support structure 330 has a forked configuration that includes a main portion 450, a first fork portion 451a, and a second fork portion 451b. The main portion 450 is located adjacent to the lower housing part 328 of the air spring 120 and is connected thereto, with a flange 352 of the main portion 450 in engagement (e.g., sealed engagement) with an exterior surface of the lower housing part 328, and with the connecting rod 348 extending through the main portion 450. The first fork portion 451a and the second fork portion 451b each extend downward from the main portion 450 and are spaced from each other by a gap 454. The gap 454 is open ended at its bottom (e.g., at the lower end of the suspension actuator assembly 116), and provides a space through which a vehicle component 455 (e.g., a propulsion shaft) can pass for connection to the wheel assembly 104. In the illustrated implementation, the bottom mount 325 extends through both of the first fork portion 451a and the second fork portion 451b. In alternative implementations, the first fork portion 451a and the second fork portion 451b are omitted and replaced by a structure that is not forked.

The air reservoir 122 provides an additional volume of working fluid (air) that is usable by the air spring 120, in addition to the internal working volume 342 of the air spring 120, during compression and expansion of the air spring 120. The air reservoir 122 is defined by a hollow interior of the support structure 330, which in this implementation functions as an air reservoir housing (e.g., a reservoir housing or a reservoir housing part). The air reservoir 122 defines a reservoir volume 356 in the hollow interior of the support structure 330. The reservoir volume 356 may be located in hollow interior portions of the support structure 330 that are located in the main portion 450, the first fork portion 451a, and the second fork portion 451b of the support structure. Because the air reservoir 122 is defined by the support structure 330 in the illustrated implementation, the air reservoir 122 forms part of the load path between the air spring 120 and the wheel assembly 104.

The air reservoir 122 is supported by the air spring housing, namely by the lower housing part 328, because the support structure 330 is fixed to the lower housing part 328. Thus, the air reservoir 122 is supported with respect to the lower housing part 328 of the air spring 120 for movement in unison with the lower housing part 328 of the air spring 120. Thus, the air reservoir 122 is supported by the air spring 120 so that it moves in unison with at least part of the air spring housing, which is defined by the upper housing part 326 and the lower housing part 328.

The reservoir volume 356 is in fluid communication with the internal working volume 342 of the air spring 120. In the illustrated implementation, the reservoir volume 356 of the air reservoir 122 is in fluid communication with the internal working volume 342 of the air spring 120 through air passages 358. To allow free flow of air between the internal working volume 342 of the air spring 120 and the reservoir volume 356 of the air reservoir 122, the air passages 358 are free from valves between internal working volume 342 of the air spring 120 and the reservoir volume 356 of the air reservoir 122.

The air passages 358 may be defined by the lower housing part 328 and extend through a bottom wall of the lower housing part 328 (e.g., through the air spring housing or a portion of the air spring housing), and the air passages 358 end at the hollow interior of the support structure 330. In alternative implementations, the air passages 358 may additionally be formed through a wall or other structure of the support structure 330. In this manner, the air passages 358 allow fluid communication between the internal working volume 342 of the air spring 120 and the reservoir volume 356 of the air reservoir 122.

Thus, the air passages 358 may extend through the lower housing part 328 for fluid communication with the internal working volume 342 of the air spring 120 and the reservoir volume 356 of the air reservoir 122 to allow exchange of air between the internal working volume 342 of the air spring 120 and the reservoir volume 356 in response to contraction and expansion of the air spring 120. In addition, fluid communication between the internal working volume 342 of the air spring 120 and the reservoir volume 356 of the air reservoir 122 through the air passages 358 defines a total working volume for the air spring 120 that includes the internal working volume 342 of the air spring 120 and the reservoir volume 356 of the air reservoir 122.

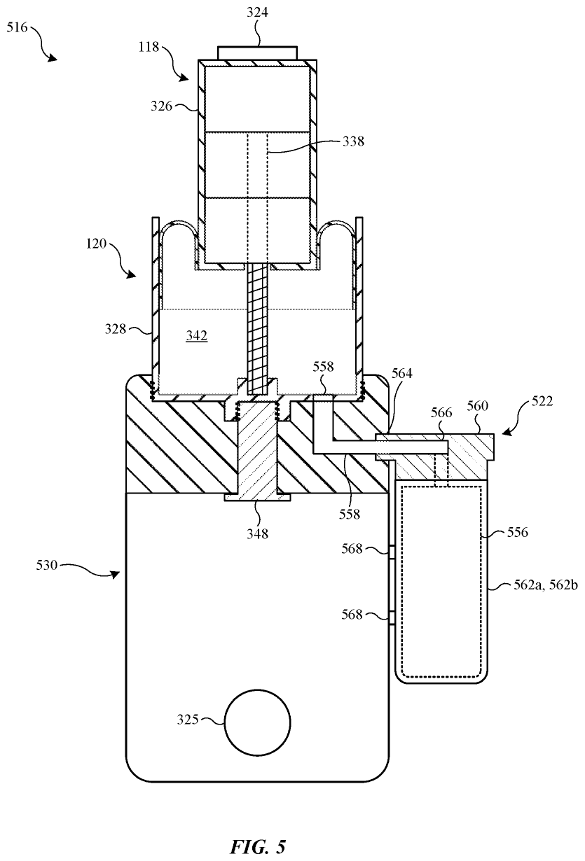

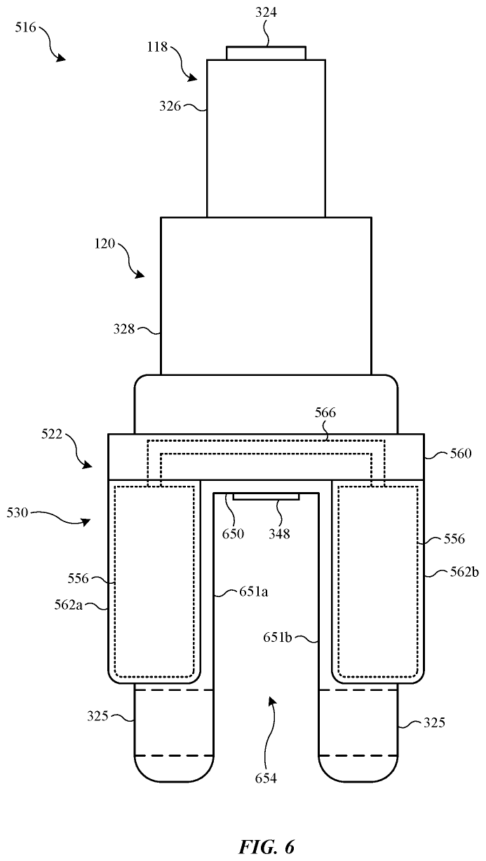

FIG. 5 is a front cross-section illustration that shows a suspension actuator assembly 516 according to a second example. FIG. 6 is a side illustration that shows the suspension actuator assembly 516. The suspension actuator assembly 516 is similar to the suspension actuator assembly 116, may be implemented in the manner described with respect to the suspension actuator assembly 116, and may be incorporated in a vehicle suspension system such as the suspension system 100 or the suspension system 200. The suspension actuator assembly 516 includes the active suspension actuator 118 and the air spring 120, which are as previously described. The suspension actuator assembly 516 also includes an air reservoir 522, which functions equivalently to the air reservoir 122 and may be implemented in the same manner, except as described herein. The suspension actuator assembly 516 also includes a support structure 530, which functions equivalently to the support structure 330 and may be implemented in the same manner, except as described herein.

In the suspension actuator assembly 516, the air reservoir 522 is not defined by a hollow interior of the support structure 530, but instead includes a manifold 560, a first air tank 562a, and a second air tank 562b. The support structure 530 may be solid instead of hollow, but includes a configuration that is similar to that described with respect to the support structure 330, including a main portion 650, a first fork portion 651a, a second fork portion 651b, and a gap 654. An air passage 558 is similar to the air passage 358, but is defined by and extends through the support structure 530 in addition to the lower housing part 328 of the air spring 120. The air passage 558 extends to a port 564 that is formed of the support structure 530 and is connected to a manifold passage 566 of the manifold 560, which is connected to a reservoir volume 556 of the air reservoir 522, which is defined in the first air tank 562a and the second air tank 562b.

The air reservoir 522 is mounted on the support structure 530 and is fixed to the support structure 530. In the illustrated implementation, the manifold 560, the first air tank 562a and the second air tank 562b are supported by direct connection to the support structure 530, and are indirectly connected to the lower housing part 328 of the air spring 120 for movement in unison with at least a portion of the air spring 120. The first air tank 562a and the second air tank 562b are adjacent to and extend along the first fork portion 651a and the second fork portion 651b, respectively. To further support the first air tank 562a and the second air tank 562b relative to the support structure 330, the first air tank 562a and the second air tank 562b may be connected to the first fork portion 651a and the second fork portion 651b, respectively, by connectors 568 such as fasteners, brackets, or straps.

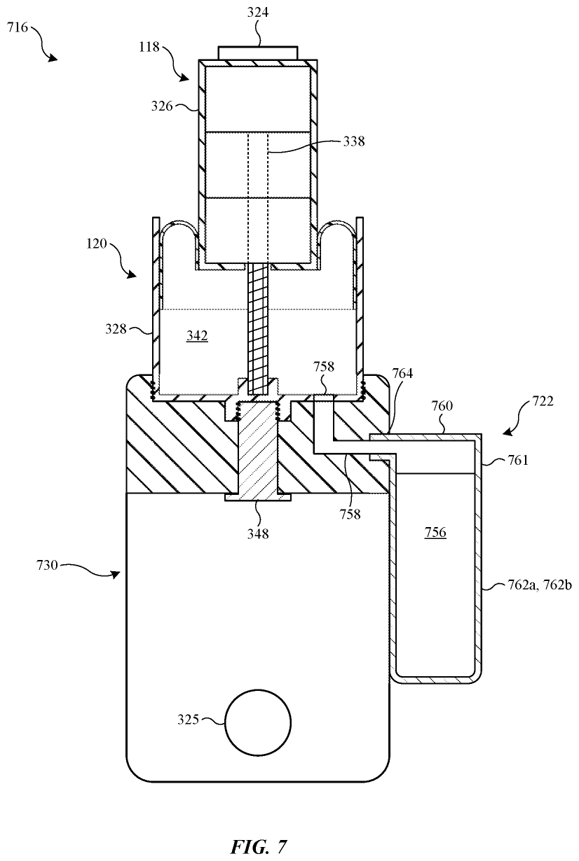

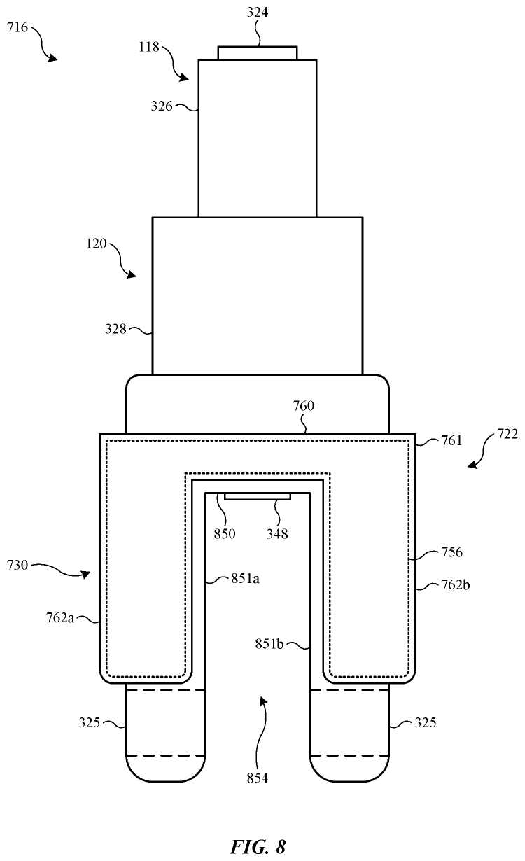

FIG. 7 is a front cross-section illustration that shows a suspension actuator assembly 716 according to a third example. FIG. 8 is a side illustration that shows the suspension actuator assembly 716. The suspension actuator assembly 716 is similar to the suspension actuator assembly 116, may be implemented in the manner described with respect to the suspension actuator assembly 116, and may be incorporated in a vehicle suspension system such as the suspension system 100 or the suspension system 200. The suspension actuator assembly 716 includes the active suspension actuator 118 and the air spring 120, which are as previously described. The suspension actuator assembly 716 also includes an air reservoir 722, which functions equivalently to the air reservoir 122 and may be implemented in the same manner, except as described herein. The suspension actuator assembly 716 also includes a support structure 730, which functions equivalently to the support structure 330 and may be implemented in the same manner, except as described herein.

In the suspension actuator assembly 716, the air reservoir 722 is not defined by a hollow interior of the support structure 730, but instead includes a reservoir housing 760, which is hollow and includes a main portion 761, a first housing fork portion 762a, and a second housing fork portion 762b. The first housing fork portion 762a and the second housing fork portion 762b extend downward from the main portion 761 in a forked configuration that is complementary to the configuration of the support structure 730. The support structure 730 may be solid instead of hollow, but includes a configuration that is similar to that described with respect to the support structure 330, including a main portion 850, a first fork portion 851a, a second fork portion 851b, and a gap 854. An air passage 758 is similar to the air passage 358, but is defined by and extends through the support structure 730 in addition to the lower housing part 328 of the air spring 120. The air passage 758 extends to a port 764 that is formed of the support structure 730 and is connected to a reservoir volume 756 of the air reservoir 722, which is defined in a hollow interior of the reservoir housing 760, inclusive of the main portion 761, the first housing fork portion 762a, and the second housing fork portion 762b.

The air reservoir 722 is mounted on the support structure 730 and is fixed to the support structure 730. In the illustrated implementation, the reservoir housing 760 of the air reservoir 722 is supported by direct connection to the support structure 730, and is indirectly connected to the lower housing part 328 of the air spring 120 for movement in unison with at least a portion of the air spring 120. The first housing fork portion 762a, and the second housing fork portion 762b are adjacent to and extend along the first fork portion 851a and the second fork portion 851b, respectively.

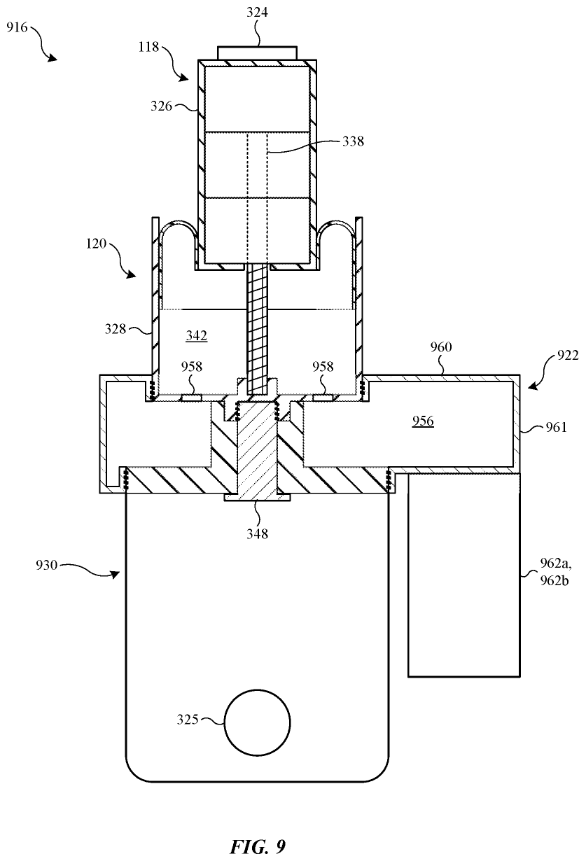

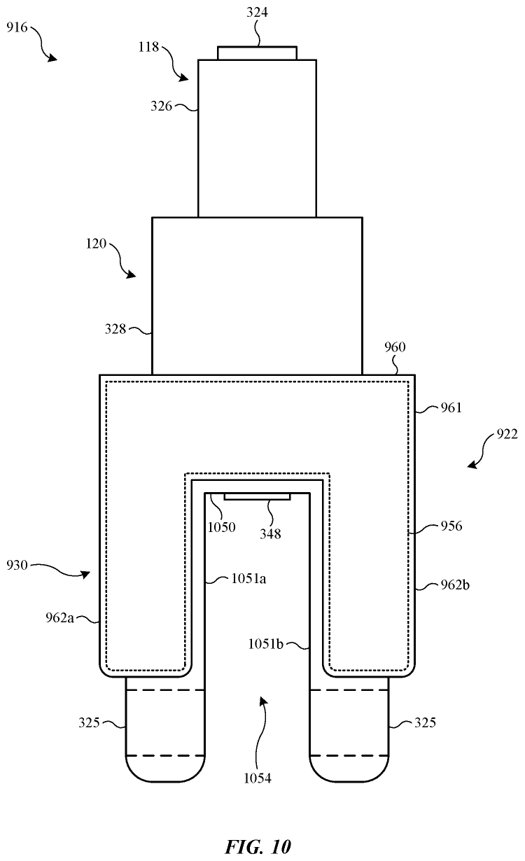

FIG. 9 is a front cross-section illustration that shows a suspension actuator assembly 916 according to a fourth example. FIG. 10 is a side illustration that shows the suspension actuator assembly 916. The suspension actuator assembly 916 is similar to the suspension actuator assembly 116, may be implemented in the manner described with respect to the suspension actuator assembly 116, and may be incorporated in a vehicle suspension system such as the suspension system 100 or the suspension system 200. The suspension actuator assembly 916 includes the active suspension actuator 118 and the air spring 120, which are as previously described. The suspension actuator assembly 916 also includes an air reservoir 922, which functions equivalently to the air reservoir 122 and may be implemented in the same manner, except as described herein. The suspension actuator assembly 916 also includes a support structure 930, which functions equivalently to the support structure 330 and may be implemented in the same manner, except as described herein.

In the suspension actuator assembly 916, the air reservoir 922 is not defined by a hollow interior of the support structure 930, but instead includes a reservoir housing 960 (e.g., a reservoir housing part), which is hollow and includes a main portion 961, a first housing fork portion 962a, and a second housing fork portion 962b. The main portion 961 of the reservoir housing 960 extends around the lower housing part 328 of the air spring 120 and also extends around the support structure 930. The main portion 961 may be connected to and/or sealed with respect to the lower housing part 328 and the support structure 930 by upper and lower flanges that extend around and engage the lower housing part 328 and the support structure 930, respectively. The first housing fork portion 962a and the second housing fork portion 962b extend downward from the main portion 961 in a forked configuration that is complementary to the configuration of the support structure 930. Alternatively, the first housing fork portion 962a and the second housing fork portion 962b may be omitted in this configuration.

The support structure 930 may be solid instead of hollow, but includes a configuration that is similar to that described with respect to the support structure 330, including a main portion 1050, a first fork portion 1051a, a second fork portion 1051b, and a gap 1054. An air passage 958 is similar to the air passage 358, and extends through the lower housing part 328 of the air spring 120 for communication with a reservoir volume 956 of the air reservoir 922. The air passage 958 may optionally be defined through the support structure 930 dependent upon the geometry of the support structure 930 and the location of the air passage 958. The reservoir volume is defined by and between the lower housing part 328, the support structure 930, and the reservoir housing 960, each of which borders the reservoir volume 956, and each of which are sealed with respect to each other. Thus, the air reservoir 922 includes a reservoir housing part, here the reservoir housing 960, that is connected to the air spring housing, here to the lower housing part 328, and is connected to the support structure 930, and the reservoir volume 956 is defined by the reservoir housing 960, the lower housing part 328, and the support structure 930.

The air reservoir 922 is mounted on the support structure 930 and is fixed to the support structure 930. In the illustrated implementation, the reservoir housing 960 of the air reservoir 922 is supported by direct connection to the support structure 930 and the lower housing part 328 of the air spring 120 for movement in unison with at least a portion of the air spring 120. The first housing fork portion 962a, and the second housing fork portion 962b are adjacent to and extend along the first fork portion 1051a and the second fork portion 1051b of the support structure 930, respectively.

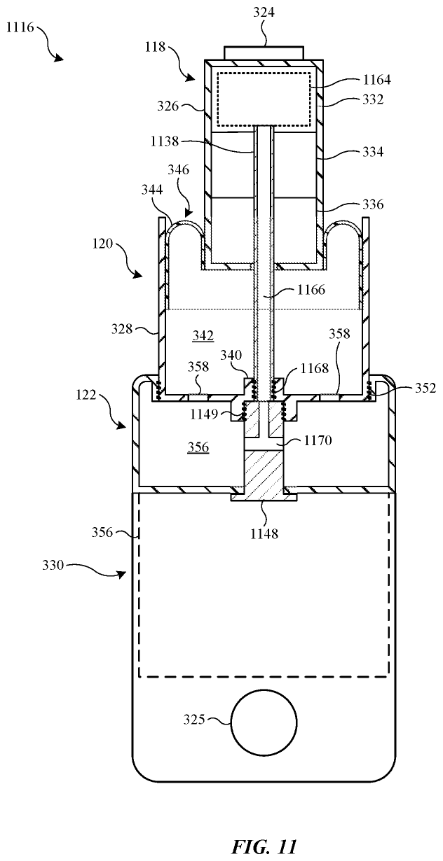

FIG. 11 is a front cross-section illustration that shows a suspension actuator assembly 1116, which is an alternative implementation of the suspension actuator assembly 116. The suspension actuator assembly 1116 is similar to the suspension actuator assembly 116, may be implemented in the manner described with respect to the suspension actuator assembly 116, and may be incorporated in a vehicle suspension system such as the suspension system 100 or the suspension system 200. The suspension actuator assembly 1116 includes the active suspension components from the suspension actuator assembly 116, which are as previously described except as further described herein.

In the suspension actuator assembly 1116, the internal working volume 342 and the reservoir volume 356 are supplemented by an actuator volume 1164 that is located in the upper housing part 326 around or adjacent to components of the active suspension actuator 118. In the illustrated example, the actuator volume 1164 is located at an upper end of the upper housing part 326, adjacent to or around the motor 332 of the active suspension actuator 118. The actuator volume 1164 provides an additional volume of air that is compressed and expanded during operation of the air spring 120, to allow desired operating characteristics (e.g., spring rate) to be achieved for the air spring 120 in a limited space.

The actuator volume 1164 is in fluid communication with the reservoir volume 356 and the internal working volume 342 through a shaft 1138 and a connecting rod 1148. The shaft 1138 is configured according to the description of the shaft 338 and functions in the same manner, but has a passageway 1166 that is located in the shaft 1138 and extends along the shaft 1138 (e.g., from a first end to a second end thereof) in an axial direction of the shaft 1138. Air may pass through the passageway 1166 of the shaft 1138 between the actuator volume 1164 and the reservoir volume 356 in response to compression and expansion. In the illustrated implementation, the shaft 1138 is connected to the connecting rod 1148 by a threaded connection 1168 to transfer forces that are applied by the active suspension actuator 118. The connecting rod 1148 may be threadedly connected to the lower housing part 328 by a threaded connection 1149, as described with respect to the connecting rod 348 and the threaded connection 349. The connecting rod includes a passageway 1170 that extends through the connecting rod 1148 and is fluidly coupled the passageway 1166 to define a further portion of the fluid communication path between the actuator volume 1164 and the reservoir volume 356. In the illustrated example, an axial end of the passageway 1170 is adjacent to the passageway 1166 and the passageway also defines radial ports that are adjacent to the interior of the air reservoir 122. As an example, the connecting rod of the passageway Although not illustrated conventional features such as sealing rings may be included to seal the connecting rod 1148 with respect to adjacent structures and thereby retain air within the actuator volume 1164, the reservoir volume 356, and the internal working volume 342.

Thus, the active suspension actuator 118 defines the actuator volume 1164, which is located in the upper housing part 326, and is in fluid communication with the internal working volume 342 of the air spring 120 through fluid communication with the reservoir volume 356. Furthermore, the actuator volume 1164 is in fluid communication with the internal working volume 342 and the reservoir volume 356 through the passageway 1166 of the shaft 1138 of the active suspension actuator 118.

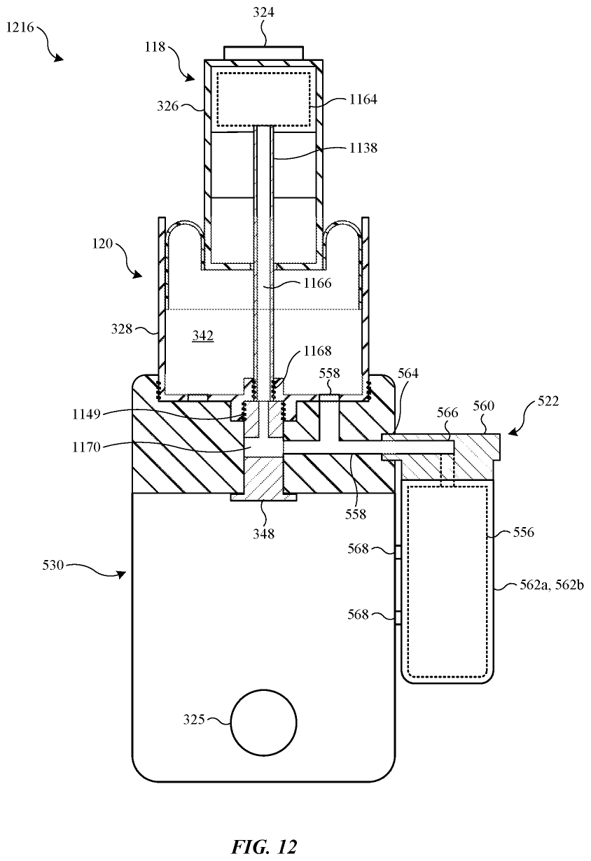

FIG. 12 is a front cross-section illustration that shows a suspension actuator assembly 1216, which is an alternative implementation of the suspension actuator assembly 516. The suspension actuator assembly 1216 is similar to the suspension actuator assembly 516, may be implemented in the manner described with respect to the suspension actuator assembly 516, and may be incorporated in a vehicle suspension system such as the suspension system 100 or the suspension system 200. The suspension actuator assembly 1216 includes the active suspension components from the suspension actuator assembly 516, which are as previously described except as further described herein.

In the suspension actuator assembly 1216, the internal working volume 342 and the reservoir volume 556 are supplemented by the actuator volume 1164, which is as previously described. The actuator volume 1164 is in fluid communication with the reservoir volume 556 of the air reservoir 522 and the internal working volume 342 through the shaft 1138 and the connecting rod 1148, which are as previously described. The threaded connection 1149 is made between the connecting rod 1148 and the support structure 530.

FIG. 12 is a front cross-section illustration that shows a suspension actuator assembly 1216, which is an alternative implementation of the suspension actuator assembly 516. The suspension actuator assembly 1216 is similar to the suspension actuator assembly 516, may be implemented in the manner described with respect to the suspension actuator assembly 516, and may be incorporated in a vehicle suspension system such as the suspension system 100 or the suspension system 200. The suspension actuator assembly 1216 includes the active suspension components from the suspension actuator assembly 516, which are as previously described except as further described herein.

In the suspension actuator assembly 1216, the internal working volume 342 and the reservoir volume 556 are supplemented by the actuator volume 1164, which is as previously described. The actuator volume 1164 is in fluid communication with the reservoir volume 556 of the air reservoir 522 and the internal working volume 342 through the shaft 1138 and the connecting rod 1148, which are as previously described, and additionally through the air passage 558 of the support structure 530.

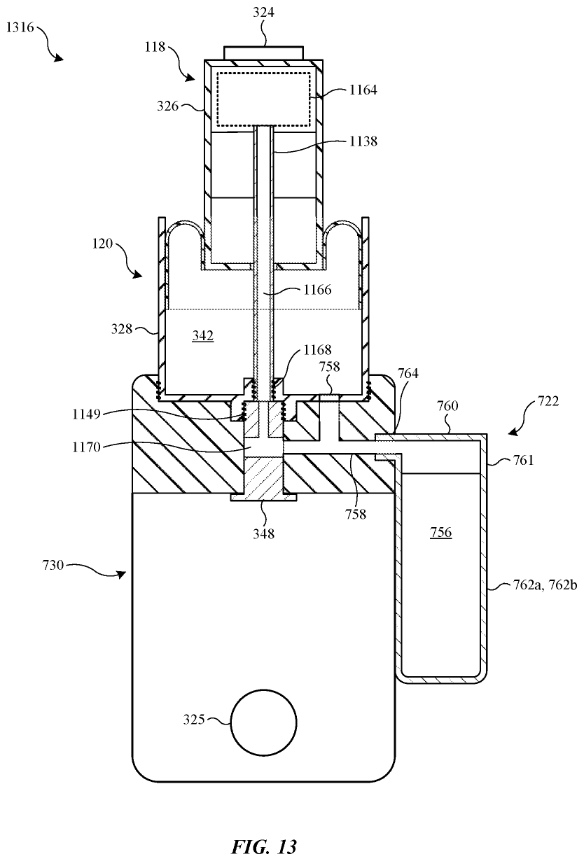

FIG. 13 is a front cross-section illustration that shows a suspension actuator assembly 1316, which is an alternative implementation of the suspension actuator assembly 716. The suspension actuator assembly 1316 is similar to the suspension actuator assembly 716, may be implemented in the manner described with respect to the suspension actuator assembly 716, and may be incorporated in a vehicle suspension system such as the suspension system 100 or the suspension system 200. The suspension actuator assembly 1316 includes the active suspension components from the suspension actuator assembly 716, which are as previously described except as further described herein.

In the suspension actuator assembly 1316, the internal working volume 342 and the reservoir volume 756 are supplemented by the actuator volume 1164, which is as previously described. The actuator volume 1164 is in fluid communication with the reservoir volume 556 of the air reservoir 522 and the internal working volume 342 through the shaft 1138 and the connecting rod 1148, which are as previously described, and additionally through the air passage 758 of the support structure 730.

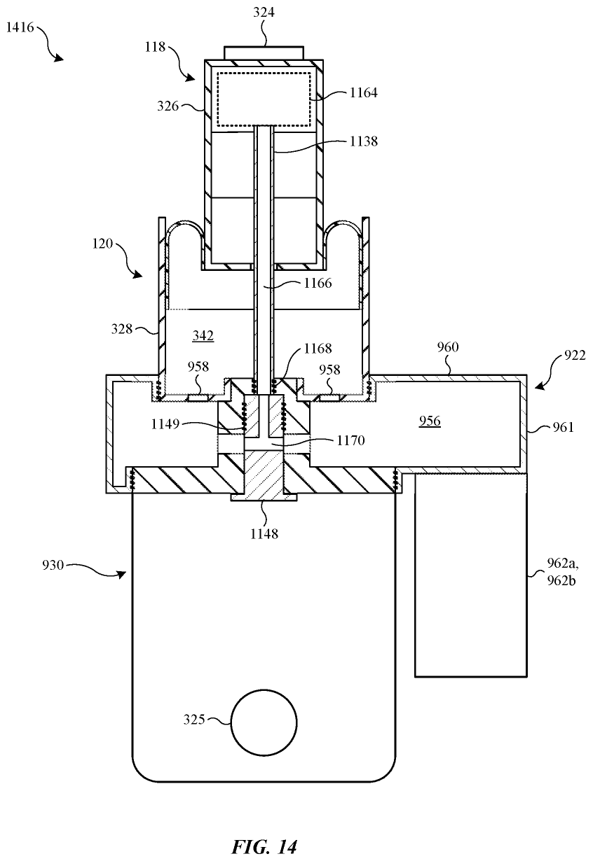

FIG. 14 is a front cross-section illustration that shows a suspension actuator assembly 1416, which is an alternative implementation of the suspension actuator assembly 916. The suspension actuator assembly 1416 is similar to the suspension actuator assembly 916, may be implemented in the manner described with respect to the suspension actuator assembly 916, and may be incorporated in a vehicle suspension system such as the suspension system 100 or the suspension system 200. The suspension actuator assembly 1416 includes the active suspension components from the suspension actuator assembly 716, which are as previously described except as further described herein.

In the suspension actuator assembly 1416, the internal working volume 342 and the reservoir volume 956 are supplemented by the actuator volume 1164, which is as previously described. The actuator volume 1164 is in fluid communication with the reservoir volume 556 of the air reservoir 522 and the internal working volume 342 through the shaft 1138 and the connecting rod 1148, which are as previously described.

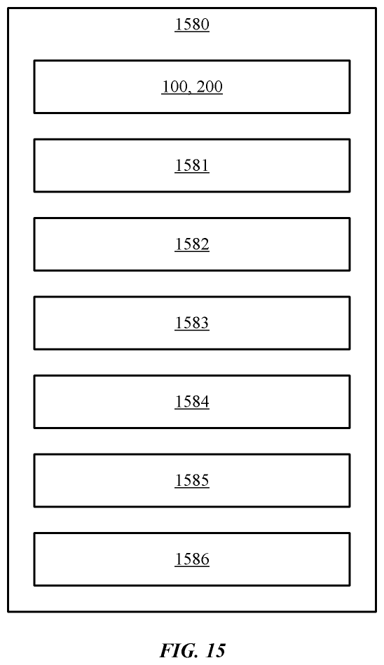

FIG. 15 is a block diagram that shows an example of a vehicle 1580 that includes a suspension system having a suspension actuator assembly according to the described implementations, such as the suspension system 100 or the suspension system 200. The vehicle 1580 may be a passenger automobile or a cargo-carrying automobile that is configured to travel on a road or other surface using wheels and tires. The vehicle 1580 may include conventional vehicle components, such as a vehicle body 1581 (e.g., including the vehicle structure 102), a propulsion system 1582, a braking system 1583, a steering system 1584, a sensing system 1585, and a control system 1586. The control system 1586 may be a general-purpose computing device (e.g., having a processor and a memory that stores instructions to be executed), or may be a general purpose computing device. The control system 1586 may control operation of the suspension system 100 or the suspension system 200, such as by adjusting ride height and executing active suspension control based on signals from sensors. The control system 1586 may also control other vehicle functions, such as autonomous driving functions. The foregoing are examples of vehicle systems that are included in the vehicle 1580. Other systems can be included in the vehicle 1580, and may be implemented according to conventional designs.

The technology described herein may involve use and storage of personal information, for example, to allow customization of vehicle suspension control according to user preferences. This personal information is used and stored in order to enhance the user's experience, and only if the user agrees to such use and storage. Collection and storage of such information should be performed using policies and practices that meet or exceed industry standards and governmental regulations. Users should be permitted to choose whether to provide personal information, whether to allow storage of personal information, and should be permitted to limit the time period over which the information is retained. Furthermore, the systems described herein may be implemented so that the use and storage of such information is optional, and so that the systems may operate without the information.

What is claimed is:

1. A suspension system, comprising:
an air spring that is configured to support a vehicle body structure with respect to a wheel assembly, wherein the air spring includes a lower housing part, an upper housing part, and an air spring membrane that define an internal working volume of the air spring, wherein the internal working volume of the air spring varies volumetrically in correspondence to movement of the lower housing part with respect to the upper housing part; and
an air reservoir that is supported with respect to the lower housing part of the air spring for movement in unison with the lower housing part of the air spring and defines a reservoir volume,
wherein the lower housing part of the air spring defines an air passage that extends through the lower housing part and is in fluid communication with the internal working volume of the air spring and the reservoir volume of the air reservoir to allow exchange of air between the internal working volume of the air spring and the reservoir volume in response to contraction and expansion of the air spring.

2. The suspension system of claim 1, further comprising:
a first mount that is configured for connection to the wheel assembly; and
a second mount that is configured for connection to the vehicle body structure, wherein the air reservoir is supported between the first mount and the second mount.

3. The suspension system of claim 1, wherein the air reservoir includes a reservoir housing part that is connected to the lower housing part of the air spring, and the reservoir volume is defined by the reservoir housing part and the lower housing part of the air spring.

4. The suspension system of claim 1, wherein the air reservoir forms part of a load path between the air spring and the wheel assembly.

5. The suspension system of claim 1, further comprising:
a support that is connected to the lower housing part of the air spring and forms part of a load path between the air spring and the wheel assembly.

6. The suspension system of claim 5, wherein the air reservoir is mounted on the support.

7. The suspension system of claim 5, wherein the air reservoir is defined by a hollow interior of the support.

8. The suspension system of claim 5, wherein the air reservoir includes a reservoir housing part that is connected to the lower housing part of the air spring and is connected to the support, and the reservoir volume is defined by the reservoir housing part, the lower housing part of the air spring, and the support.

9. The suspension system of claim 1, wherein fluid communication between the internal working volume of the air spring and the reservoir volume of the air reservoir through the air passage defines a total working volume for the air spring that includes the internal working volume of the air spring and the reservoir volume of the air reservoir.

10. The suspension system of claim 1, wherein the air passage is free from valves between internal working volume of the air spring and the reservoir volume of the air reservoir.

11. The suspension system of claim 1, further comprising:
an active suspension actuator that is connected to the upper housing part and the lower housing part and is configured to move the upper housing part and the lower housing part relative to each other, wherein the active suspension actuator defines an actuator volume that is located in the upper housing part and is in fluid communication with the internal working volume of the air spring.

12. The suspension system of claim 11, wherein the active suspension actuator includes a shaft that is configured to transfer load between the upper housing part and the lower housing part, a passage is formed through the shaft, and the actuator volume is in fluid communication with the internal working volume of the air spring through the passage of the shaft.

13. The suspension system of claim 1, wherein the air reservoir has a forked configuration.

14. A suspension system, comprising:
an air spring that is configured to support a vehicle body structure with respect to a wheel assembly, wherein the air spring includes an air spring housing and an air spring membrane that define an internal working volume of the air spring;
an air reservoir that is supported by the air spring housing with respect to the lower housing part of the air spring and defines a reservoir volume that is in fluid communication with the internal working volume of the air spring; and
a support that is connected to the air spring housing and forms part of a load path between the air spring and the wheel assembly.

15. The suspension system of claim 14, wherein the air reservoir is mounted on the support.

16. The suspension system of claim 14, wherein the air reservoir is defined by a hollow interior of the support.

17. A suspension system, comprising:
an air spring that defines an internal working volume;
an air reservoir that defines a reservoir volume and is in fluid communication with the internal working volume of the air spring so that the internal working volume of the air spring and the reservoir volume of the air reservoir define a total a working volume for the air spring;
an upper mounting structure that is configured for connection to a vehicle body structure;
a lower mounting structure that is configured for connection to a wheel assembly; and
a support that defines a load path between the air spring and the lower mounting structure, wherein the air reservoir is fixed to the support.

18. The suspension system of claim 17, wherein the air reservoir has a forked configuration.

19. The suspension system of claim 18, wherein the air reservoir includes a first air tank that is located adjacent to a first fork portion of the support structure and a second air tank that is located adjacent to a second fork portion of the support structure.

20. The suspension system of claim 18, wherein the air reservoir includes a reservoir housing that includes a first housing fork portion that is located adjacent to a first fork portion of the support structure, and a second housing fork portion that is located adjacent to a second fork portion of the support structure.
